(19) United States
(12) Patent Application Publication
(10) Pub. No.: US 2019/0016057 A1
(43) Pub. Date: Jan. 17, 2019

(54) SHELL SUPPORT GENERATION METHOD

(71) Applicant: 3D Systems, Inc., Rock Hill, SC (US)

(72) Inventor: Chris Robert Manners, Moorpark, CA (US)

(21) Appl. No.: 16/037,210

(22) Filed: Jul. 17, 2018

Related U.S. Application Data
(60) Provisional application No. 62/533,378, filed on Jul. 17, 2017.

(51) Int. Cl. B29C 64/393; B33Y 50/02; B33Y 40/00; B29C 64/40

(52) U.S. Cl. CPC B29C 64/393; B33Y 50/02; B33Y 10/00; B29C 64/40; B33Y 40/00

(57) ABSTRACT

A three dimensional printing system includes a controller that performs a method of fabricating a three dimensional article of manufacture. The method includes steps A and B including (A) providing initial data defining a three dimensional object having a defined outer surface and (B) modifying the initial data to define a shelled and supported three dimensional object. Step B includes (1) defining a cavity inside the defined outer surface, the cavity bounded by an inner surface, the three dimensional object is a shell with a shell thickness between the defined outer surface and the inner surface, (2) analyzing lateral sections of the object to detect portions of the lateral sections that are unconnected or unsupported portions for a given lateral section, and (3) generating a support beam that connects an unconnected or unsupported portion of a lateral section to another portion of the shell.

### CROSS-REFERENCE TO RELATED APPLICATIONS

This non-provisional patent application claims priority to U.S. Provisional Application Ser. No. 62/533,378, Entitled “Shell Support Generation Method” by Chris Robert Manners, filed on Jul. 17, 2017, incorporated herein by reference under the benefit of U.S.C. 119(e).

### FIELD OF THE INVENTION

The present disclosure concerns an apparatus and method for the digital fabrication of three dimensional articles of manufacture. More particularly, the present invention concerns an efficient way of reducing material usage while maintaining structural integrity of a model.

### BACKGROUND

Three dimensional printers are in widespread use. Examples of three dimensional printer technologies includes stereolithography, selective laser sintering, and fused deposition modeling to name a few. Some three dimensional printers require that the three dimensional article be supported with a different support material or a support structure made of the same material. A need exists to minimize or eliminate such support materials or support structures for some three dimensional articles.

### BRIEF DESCRIPTION OF THE FIGURES

FIG. 1A is a schematic block diagram depicting a first embodiment of a three dimensional printing system.

FIG. 1B is a schematic block diagram depicting a second embodiment of a three dimensional printing system.

FIG. 2 is a flowchart depicting a part of a method for forming a three dimensional article of manufacture utilizing the system of FIG. 1A or 1B.

FIG. 3A depicts a cross section (shaded) through an initially solid model 60.

FIG. 3B is a cross sectional view depicting the division (dashed lines) between “lateral sections” which each include N slices.

FIG. 3C depicts a slice taken from the indicated location of FIG. 3B.

FIG. 3D depicts the slice of FIG. 3C with a window of material removed.

FIG. 3E is a cross sectional view depicting a “shelled” model 70.

FIG. 3F depicts a lateral section indicated as 3F in FIG. 3E.

FIG. 3G depicts the lateral section of FIG. 3F with a beam that couples an unsupported portion of the lateral section with a peripheral portion.

FIG. 3H is a cross sectional view depicting a shelled and supported model 78.

FIG. 4A depicts the use of a lateral beam having a minimized dimension.

FIG. 4B is a cross sectional view depicting a shelled and supported model 78 using the minimized beam of FIG. 4A.

### SUMMARY

In a first aspect of the disclosure a three dimensional printing system includes a controller that performs a method of fabricating a three dimensional article of manufacture. The method includes steps A and B including (A) providing initial data defining a three dimensional object having a defined outer surface and (B) modifying the initial data to define a shelled and supported three dimensional object. Step B includes (1) defining a cavity inside the defined outer surface, the cavity bounded by an inner surface, the three dimensional object is a shell with a shell thickness between the defined outer surface and the inner surface, (2) analyzing lateral sections of the three dimensional object to detect portions of the lateral sections that are unconnected or unsupported portions for a given lateral section as a result of step (1), and (3) generating a beam that connects an unconnected or unsupported portion of a lateral section to another portion of the shell.

In a second aspect of the disclosure a three dimensional printing system includes a controller that performs a method of fabricating a three dimensional article of manufacture. The method of certain embodiments includes the following steps: (A) Providing or receiving initial data defining a three dimensional object. (B) Modifying the initial data to define a shelled and supported three dimensional object according to the following steps: (1) Slicing the three dimensional object into slices individually having an outer boundary. (2) For individual slices, defining an inner boundary within the outer boundary whereby the inner boundary defines an opening in the slice and whereby the defined openings for multiple consecutive slices define a cavity inside the three dimensional object, the cavity bounded by an inner surface. (3) Processing the data defining the inner surface whereby a shell of desired thickness is formed between an outer surface of the three dimensional object and the inner surface. (4) Defining lateral sections of one or more consecutive slices and searching the lateral sections for unconnected or unsupported portions of the lateral sections. (5) When an unconnected or unsupported portion of a lateral section is found, generating a support beam that couples the unconnected or unsupported portion of the lateral section to another portion of the shell.

In one implementation, the support beam can be laterally extending. In another implementation, the support beam can be vertically extending. In yet another implementation an extension of the support beam can have both vertical and lateral components.

In a third aspect of the disclosure a three dimensional printing system includes a controller that performs a method of fabricating a three dimensional article of manufacture. The method of certain embodiments includes the following steps: (A) Providing or receiving initial data defining a three dimensional object. (B) Modifying the initial data to define a shelled and supported three dimensional object according to the following steps: (1) Slicing the three dimensional object into slices of thickness t and individually having outer boundaries. (2) Defining lateral sections individually including N slices and thereby individually having a shell thickness S equal to N times t. (3) For individual slices, defining an inner boundary within the outer boundary whereby the inner boundary defines an opening in the slice and whereby the defined openings for multiple consecutive slices define a cavity inside the three dimensional object, the cavity bounded by an inner surface that is surrounded by an outer surface of the three dimensional object with an initial shell therebetween. (4) Processing data defining the inner surface and the outer surface including projecting up facing surfaces downward by a defined distance and down facing surfaces downward by a defined distance and doing a boolean union between the initial shell and projected material to define a shell having a thickness of about S between the inner and outer surfaces. (5) Analyzing the lateral sections to identify unconnected or unsupported portions of the lateral sections. (6) When an unconnected or unsupported portion of a lateral section is found, generating a support beam that couples the unconnected or unsupported portion of the lateral section to another portion of the shell.

In one implementation, the support beam can be laterally extending. In another implementation, the support beam can be vertically extending. In yet another implementation an extension of the support beam can have both vertical and lateral components.

### DETAILED DESCRIPTION OF THE PREFERRED EMBODIMENTS

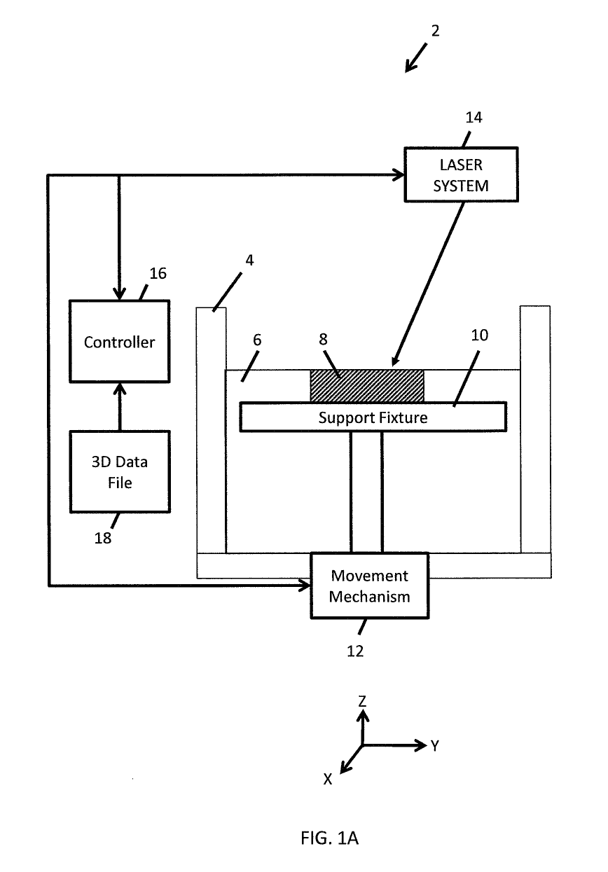

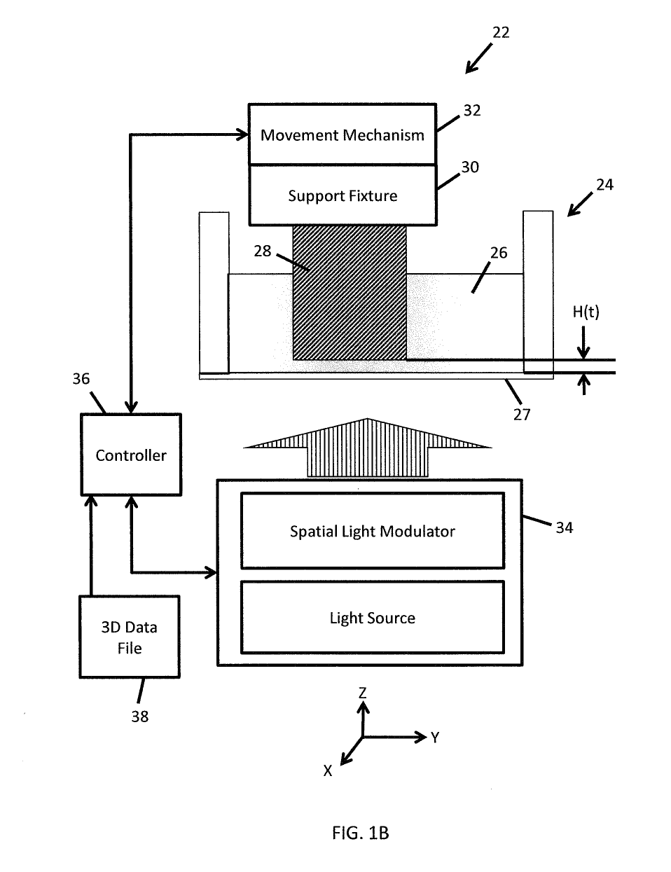

FIG. 1A is a schematic block diagram depicting a first embodiment of a three dimensional (3D) printing system 2. In this and other figures, mutually perpendicular axes X, Y and Z will be used. Axes X and Y are lateral axes. In some embodiments X and Y are also horizontal axes. Axis Z is a central axis. In some embodiments Z is a vertical axis. In some embodiments the direction +Z is generally upward and the direction −Z is generally downward.

Three dimensional printing system 2 includes a vessel 4 containing photocurable resin 6. A three dimensional article of manufacture 8 is being formed upon a support fixture 10. The three dimensional article of manufacture 8 is formed in a layer-by-layer manner by the action of movement mechanism 12 and laser system 14 in polymerizing layers of the photocurable resin 6. Further embodiments of the present invention comprise alternative three dimensional printing systems that may or may not use photocurable resins to fabricate the three dimensional article.

The three dimensional printing system 2 of FIG. 1A includes a controller 16 coupled to the movement mechanism 12, the laser system 14, and other portions of the three dimensional printing system 2. The controller 16 initially receives an initial data file 18 that defines a three dimensional object having a defined outer surface. The controller 16 processes and modifies the initial data file 18 resulting in a modified data file. The modified data file defines a shelled and supported three dimensional object 8. The controller then utilizes the modified data file to control the movement mechanism 12, the laser system 14, and to form a shelled and supported three dimensional article of manufacture 8.

The three dimensional printing system 2 initially operates by placing a thin layer of the resin 6 atop the support fixture 10. Laser system 14 selectively scans a laser beam over the thin layer of resin 6 to define a “slice” of the three dimensional article of manufacture 8. Then the movement mechanism 12 lowers the support fixture 10 by one slice thickness and a new layer of resin is made to reside over the three dimensional article of manufacture 8. The laser system then selectively scans a laser beam over the new layer of resin to incrementally form a new slice of hardened resin onto the three dimensional article of manufacture 8. This process continues until the three dimensional article of manufacture 8 is fully formed. Further embodiments of the present invention include alternative light sources, such a spatial light modulators or other light sources currently existing or hereafter devised.

Controller 16 of FIG. 1A includes a processor (not shown) coupled to an information storage device (not shown). The information storage device stores instructions which, when executed, modify the initial data file 18 and operate components of printing system 2 including the movement mechanism 12 and the laser system 14. The controller 16 can be located on one module, circuit board, or substrate, or it can be distributed at multiple locations internal and/or external relative to a location of printing system 2. Controller 16 can entail a number of different computers including client devices, servers, and processors that are co-located or distributed at multiple geographic locations.

FIG. 1B depicts a second embodiment of a three dimensional printing system 22. A vessel 24 contains photocurable resin 26. A transparent sheet 27 forms a lower bound for the photocurable resin 26. A three dimensional article of manufacture 28 is being formed on a support fixture 30. The three dimensional article of manufacture 28 is being formed in a layer-by-layer manner by the action of movement mechanism 32 and light engine 34 in polymerizing layers of the photocurable resin 26 onto a lower surface of the support fixture 30.

The three dimensional printing system 22 includes a controller 36 coupled to the movement mechanism 32, the light engine 34, and other portions of the three dimensional printing system 22. The controller 36 initially receives an initial data file 38 that defines a three dimensional object having a defined outer surface. The controller 36 processes and modifies the initial data file 38 resulting in a modified data file. The modified data file defines a shelled and supported three dimensional object 28. The controller then utilizes the modified data file to control the movement mechanism 32, the light engine 34, and to form a shelled and supported three dimensional article of manufacture 28.

Initially there is a thin layer of resin separating a lower surface of the support fixture 30 and the transparent sheet 27. The light engine 34 projects pixelated light up through the transparent sheet 27 to selectively cure portions of the thin layer of resin to thereby define a “slice” of the three dimensional article of manufacture 28. Then the movement mechanism 32 raises the support fixture 20 by one slice thickness. The light engine 34 then projects pixelated light up through the transparent sheet 27 to form the next slice of hardened resin onto a lower face of the three dimensional article of manufacture 28. This process continues until the three dimensional article of manufacture 28 is fully formed.

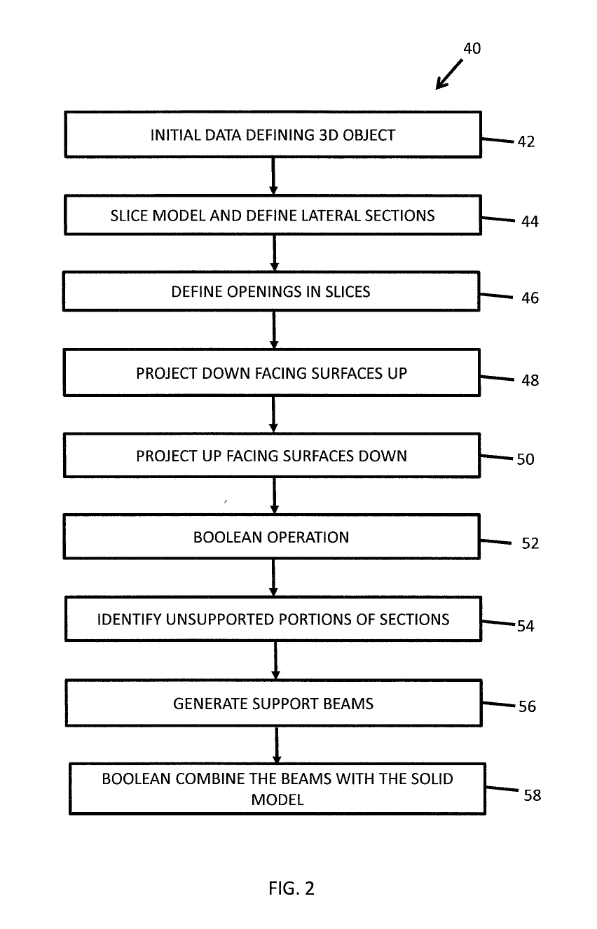

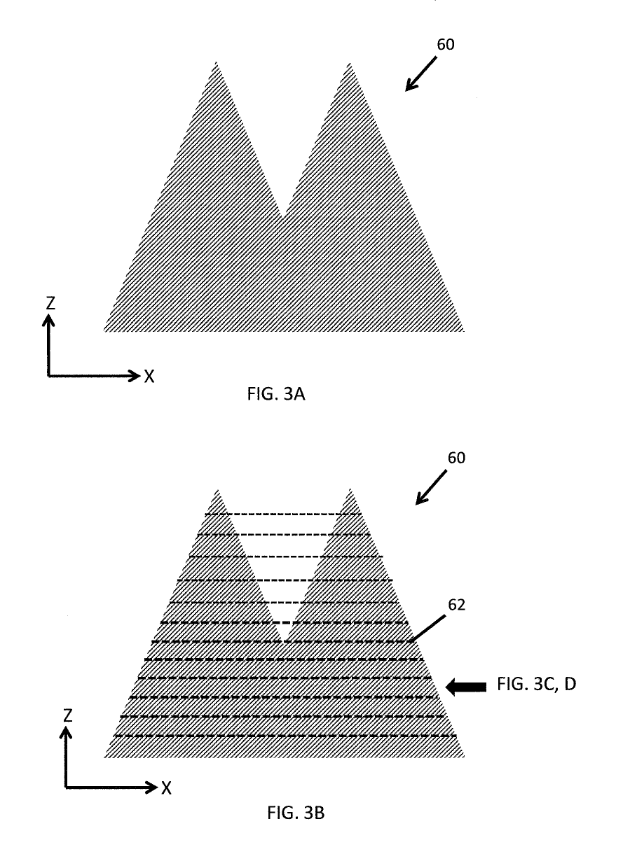

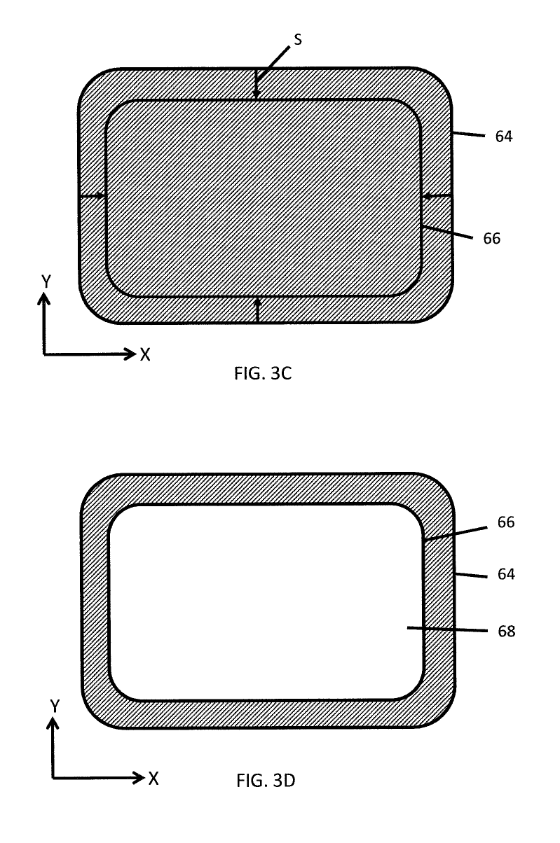

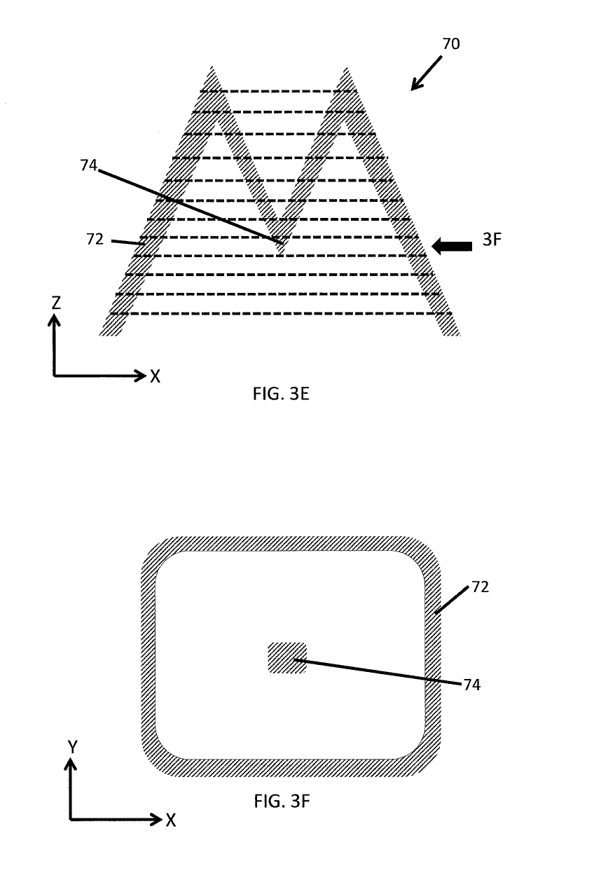

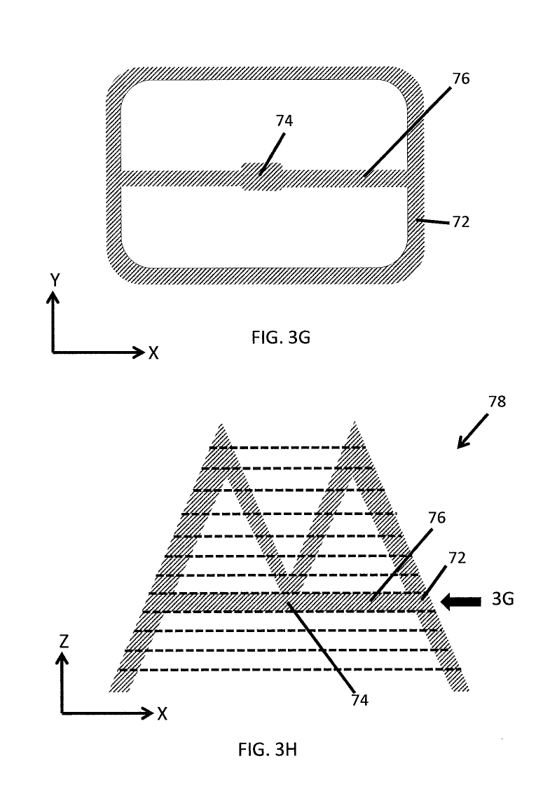

FIG. 2 is a flowchart depicting part of a method for forming a three dimensional article of manufacture 8 or 28. FIGS. 3A-H are exemplary illustrations of some of the processes of method 40.

According to step 42, the controller 16 receives an initial data file 18 or 38 that defines a three dimensional object. The initial data defines an object that is typically solid. This is depicted in FIG. 3A that illustrates a cross section through an initial solid object 60. The illustrated object 60 has a geometry that will facilitate a description of the remaining steps of method 40. The shaded or hatched area represents solid material (no internal cavities) in solid object 60.

According to step 44 the solid object 60 is sliced into horizontal slices of individual thickness t. The horizontal slices represent individual thicknesses that can be polymerized by the operation of laser system 14 before incrementally lowering the support fixture 10 (FIG. 1A). Alternatively the horizontal slices represent individual thicknesses that can be polymerized by the light engine 34 before incrementally raising support fixture 30 (FIG. 1B). In one embodiment t is about 0.1 millimeter (mm).

Also as part of step 44 there are lateral sections defined. A lateral section is defined as a stack of N consecutive slices. Thus, a lateral section has a thickness equal to S=N times t. In one embodiment S equals a shell thickness. In a particular embodiment, N=20 and S=2.0 millimeters (mm). FIG. 3B depicts the solid model 60 divided up into lateral sections by horizontal section lines 62.

According to step 46, openings are formed in the slices. FIG. 3C depicts a slice taken from the indicated location of FIG. 3B. The slice has an outer boundary 64. An inner boundary 66 is defined according to an inward distance S that is perpendicular to the outer boundary. Also according to step 46, the inner boundary is “inverted” so as to define a window or opening 68 that is bounded by the inner boundary 66 as depicted in FIG. 3D. When this is performed for many or all slices in the model 60, the result is a hollow model.

According to step 48, certain downward facing surfaces of the slices are projected upwardly by the distance S. According to step 50, certain upward facing surfaces are projected downwardly by the distance S. According to step 52 a boolean union operation is performed on the combination of the prior 3D model and the projected material from steps 48 and 50 to eliminate redundant overlapping material. The result is a hollow shell (or a shelled three dimensional object) 70 as illustrated in FIG. 3E.

According to step 54, the data is analyzed to identify portions of lateral sections that are unsupported by material below (or above for some printing system embodiments). FIG. 3F is a cross section of the indicated section from FIG. 3E. The indicated section has supported outer portion 72 and an unsupported or unconnected portion 74. Unsupported portion 74 does not have any underlying material support.

According to step 56 at least one support beam 76 is coupled between the unsupported or unconnected portion 74 to the supported outer portion 72 of the lateral section as illustrated in FIGS. 3G and 3H. In the illustrated embodiment, the support beam 76 is extended along the X-axis and couples the unsupported portion 74 to the supported outer portion 72 of the lateral section in two locations. According to step 58, a boolean operation is performed to eliminate redundant material between the supported outer portion 72, beam(s) 76, and the unsupported portion 74. The result is a shelled and supported three dimensional object 78. In further embodiments, the support beam extends along the X-axis, the Y-axis, and/or the Z-axis.

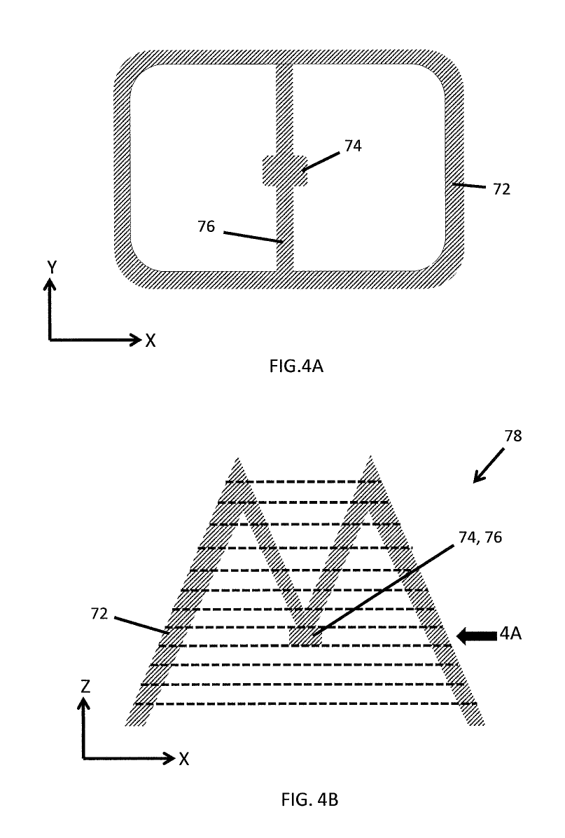

In one embodiment, part of step 56 is a determination of a shortest beam(s) 76 that will couple the unsupported portion 74 to the supported outer portion 72. Then the beam 76 is oriented along that direction in order to reduce material usage. Such is illustrated in FIGS. 4A and 4B. In the illustrated embodiment, the shortest beam can be defined along the Y-axis. However, in other embodiments the shortest beam might be defined along a direction having both X and Y component vectors.

The specific embodiments and applications thereof described above are for illustrative purposes only and do not preclude modifications and variations encompassed by the scope of the following claims.

What we claim is:

1. A method of fabricating a three dimensional article of manufacture comprising:
providing initial data defining a three dimensional object having a defined outer surface;
modifying the initial data to define a shelled and supported three dimensional object according to the following steps:
defining a cavity inside the defined outer surface, the cavity bounded by an inner surface, the three dimensional object is a shell with a shell thickness between the defined outer surface and the inner surface;
analyzing lateral sections of the three dimensional object to detect portions of the lateral sections that are unconnected or unsupported portions for a given lateral section; and
generating a support beam that connects an unconnected or unsupported portion of a lateral section to another portion of the shell.

2. The method of claim 1 wherein the three dimensional object defined by the initial data is a mostly or entirely solid object.

3. The method of claim 1 wherein defining the cavity includes forming openings in individual slices of the three dimensional object.

4. The method of claim 3 wherein defining the cavity includes thickening portions of the shell to provide a desired shell thickness.

5. The method of claim 1 wherein analyzing lateral sections includes searching for a lateral section that does not have material support above or below the lateral section.

6. The method of claim 1 further comprising determining an orientation of the support beam that minimizes use of material before generating the support beam.

7. The method of claim 1 further comprising printing a shell having the defined outer surface using the modified data.

8. The method of claim 1 wherein the support beam is a lateral beam that laterally supports the unconnected or unsupported portion of the lateral section to another portion of the shell.

9. A method of fabricating a three dimensional article of manufacture comprising:
providing initial data defining a three dimensional object; and
modifying the initial data to define a shelled and supported three dimensional object according to the following steps:
slicing the three dimensional object into slices individually having an outer boundary;
for individual slices, defining an inner boundary within the outer boundary whereby the inner boundary defines an opening in the slice and whereby the defined openings for multiple consecutive slices define a cavity inside the three dimensional object, the cavity bounded by an inner surface;
processing the data defining the inner surface whereby a shell of desired thickness is formed between an outer surface of the three dimensional object and the inner surface;
defining lateral sections of one or more consecutive slices and searching the lateral sections for unconnected or unsupported portions of the lateral sections; and
when an unconnected or unsupported portion of a lateral section is found, generating a support beam that couples the unconnected or unsupported portion of the lateral section to another portion of the shell.

10. The method of claim 9 further comprising processing the data of the outer surface for forming the shell of desired thickness.

11. The method of claim 10 wherein processing the data defining the inner and outer surfaces includes defining projections of upward and downward facing surfaces.

12. The method of claim 11 wherein processing the data further includes forming a boolean union between the three dimensional object and the projections to eliminate redundant overlapping voxels.

13. The method of claim 9 wherein the lateral sections individually include a plurality of consecutive slices.

14. The method of claim 13 wherein the lateral sections have a thickness that is approximately the same as the shell.

15. The method of claim 9 further comprising determining an orientation of the support beam that minimizes use of material before generating the support beam.

16. The method of claim 9 further comprising printing a shell using the modified data.

17. A method of fabricating a three dimensional article of manufacture comprising:
providing initial data defining a three dimensional object; and
modifying the initial data to define a shelled and supported three dimensional object according to the following steps:
slicing the three dimensional object into slices of thickness t and individually having outer boundaries;
defining lateral sections individually including N slices and thereby individually having a shell thickness S equal to N times t;
for individual slices, defining an inner boundary within the outer boundary whereby the inner boundary defines an opening in the slice and whereby the defined openings for multiple consecutive slices define a cavity inside the three dimensional object, the cavity bounded by an inner surface that is surrounded by an outer surface of the three dimensional object with an initial shell therebetween;
processing data defining the inner surface and the outer surface including projecting up facing surfaces downward by a defined distance and down facing surfaces downward by a defined distance and doing a boolean union between the initial shell and projected material to define a shell having a thickness of about S between the inner and outer surfaces;
analyzing the lateral sections to identify unconnected or unsupported portions of the lateral sections; and
when an unconnected or unsupported portion of a lateral section is found, generating a support beam that couples the unconnected or unsupported portion of the lateral section to another portion of the shell.

18. The method of claim 17 wherein the defined distance for projecting surfaces is approximately equal to S.

19. The method of claim 17 further comprising determining an orientation of the support beam that minimizes use of material before generating the support beam.

20. The method of claim 17 further comprising printing a shell using the modified data.
